(19) United States
(12) Patent Application Publication
(10) Pub. No.: US 2019/0121160 A1
(43) Pub. Date: Apr. 25, 2019

(54) Eyeglasses having a temple piece with magnetic properties

(71) Applicant: nicholas pfeifer, clearwater, FL (US)

(72) Inventor: nicholas pfeifer, clearwater, FL (US)

(21) Appl. No.: 15/698,866

(22) Filed: Sep. 8, 2017

(51) Int. Cl. G02C 5/14

(52) U.S. Cl. CPC G02C 5/14; G02C 2200/02; G02C 5/143

(57) ABSTRACT

At least one temple piece on a pair of eyeglasses configured to magnetically attach to another portion of the eyeglasses when the temple piece is folded inwards towards the lenses. The temple piece may employ an apparatus, attached thereto, having a magnet or magnetic material to temporarily mate the temple piece to a magnetically receptive portion of the eyeglasses or to the other temple piece having a similar apparatus secured thereto. The method of securing a temple piece to another portion of the eyeglasses effectively creates a closed latch for securely hanging the eyeglasses from an object. In addition, the temple piece can secure a pair of eyeglasses to a clothing item by pinching the clothing fabric between the temple piece and the rest of the eyeglasses, similar to a magnetically secured name tag.

### BACKGROUND OF THE INVENTION

### 1. Field of the Invention

This invention relates, generally, to eyeglasses. More specifically, it relates to eyeglasses having magnetic materials integrated into or secured to the temple pieces of a pair of eyeglasses.

### 2. Brief Description of the Prior Art

Currently, there a limited options for temporarily storing one's eyeglasses on their person. Some options include carrying the eyeglasses in hand, storing them within a clothing pocket, placing them in a personal bag, and hanging them from a clothing item by sliding one temple piece within the neck portion of the clothing item. Each option, however, has its drawbacks.

In particular, the last option of sliding one temple piece within the neck portion of a clothing item is susceptible to falling when a user bends over from an upright position. The weight of the eyeglasses combined with the inherent yielding characteristic of clothing causes the portion of the eyeglasses external from the clothing item to extend away from the temple piece located within the clothing item. As a result, the eyeglasses falls from their perch. This problem can be overcome if the temple pieces of the eyeglasses remained secured to each other through the clothing item, effectively clamping the eyeglasses to the clothing item.

Accordingly, what is needed is a pair of eyeglasses having at least one temple piece adapted to magnetically secure to the other temple piece or another portion of the eyeglasses. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for a pair of eyeglasses having at least one temple piece adapted to magnetically secure to the other temple piece or another portion of the eyeglasses is now met by a new, useful, and nonobvious invention.

The novel structure includes a pair of eyeglasses comprising a first magnetic device secured to or incorporated into a first temple piece on the pair of eyeglasses and a second magnetic device secured to or incorporated into a second temple piece on the pair of eyeglasses. The first and second magnetic devices are each located along their respective temple pieces at locations that cause a magnetic field of the first magnetic device to reside within a magnetic field of the second magnetic device when the first and second temple pieces are folded inwardly towards a frame of the pair of eyeglasses. The magnetic fields of the first and second magnetic devices are oriented such that the two magnetic fields produce an attraction force thereby pulling the first and second temple pieces into contact with each other and the attraction force has a force value greater than the weight of the pair of eyeglasses when the first and second temple pieces are in contact with each other.

The novel method for securing a eyeglasses to an article of clothing includes placing a first temple piece proximate a first surface of the article of clothing, wherein the first temple piece includes a magnetic device incorporated therein or attached thereto. A second temple piece if folded towards a frame of the eyeglasses about a hinge connecting the second temple piece to the frame of the eyeglasses, wherein the second temple piece includes a magnetic device incorporated therein or attached thereto. The combination of the frame of the eyeglasses and the second temple piece is then folded towards the first temple piece about a hinge connecting the first temple piece to a frame of the eyeglasses, wherein the combination of the frame of the eyeglasses and the second temple piece resides on a second surface of the article of clothing such that the article of clothing is sandwiched between the first temple piece and the combination of the frame of the eyeglasses and the second temple piece. Finally a magnetic field of the magnetic device incorporated or attached to the first temple piece is allowed to reach a magnetic field of the magnetic device incorporated or attached to the second temple piece, thereby causing the first and second temple pieces to magnetically attach to each other securing the article of clothing therebetween.

An object of the invention is to provide a more effective means for securing a pair of eyeglasses to an article of clothing.

Another object of the invention is to provide a means for temporarily securing a pair of eyeglasses to a magnetic structure for safe storage.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a perspective view of an embodiment of the present invention.

FIG. 2A is a perspective view of an embodiment of the magnetic sleeve shown in FIG. 1.

FIG. 2B is a perspective view of an embodiment of the magnetic sleeve shown in FIG. 1.

FIG. 2C is a perspective view of an embodiment of the magnetic sleeve shown in FIG. 1.

FIG. 3 is a perspective view of an embodiment of the present invention.

FIG. 4 is a close-up perspective view of an embodiment of the present invention.

FIG. 5 is a close-up is a perspective view of an embodiment of the present invention depicting two temple pieces in overlapping secured relation.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

The present invention provides an apparatus and method for magnetically securing at least one temple piece on a pair of eyeglasses to the other temple piece or another portion of the eyeglasses. The term “eyeglasses” is not intended to limit the invention to glasses containing corrective lens. Rather, the term encompasses any type of glasses intended to reside in covering relation to a user's eyes. The term “temple piece” refers to a support members hingedly secured to the frame of pair of eyeglasses proximate to a lateral end of the frame. The temple piece is intended rest proximate to a user's temple and overtop a user's ear when the eyeglasses are properly worn.

The present invention is designed to ensure that at least one temple piece 102 become magnetically secured to the eyeglasses, in an inwardly folded configuration, when the temple piece 102 is inserted within a clothing item while the remainder of the eyeglasses remains external to the clothing item. Magnets 108 cause temple pieces 102 to pinch the clothing item disposed between folded temple pieces 102 and prevent the eyeglasses 101 from failing and becoming damaged. As a secondary benefit, magnetically fixing the two temple pieces together effectively turns the frame and temple pieces into a constructive latch. Therefore, the glasses can be protectively secured at any number of useful location, such as a bag strap or belt loop.

Another useful benefit achieved by the magnetic properties of the present invention is the ability to store the eyeglasses to any magnetically receptive object. For example, a magnetic plate could be secured to a wall near a front door or on the dash of a car and a user could simple magnetically attach his/her eyeglasses directly to the magnetic plate. Alternatively, a user could store his/her glasses to a fridge or any other household object receptive to magnetic forces.

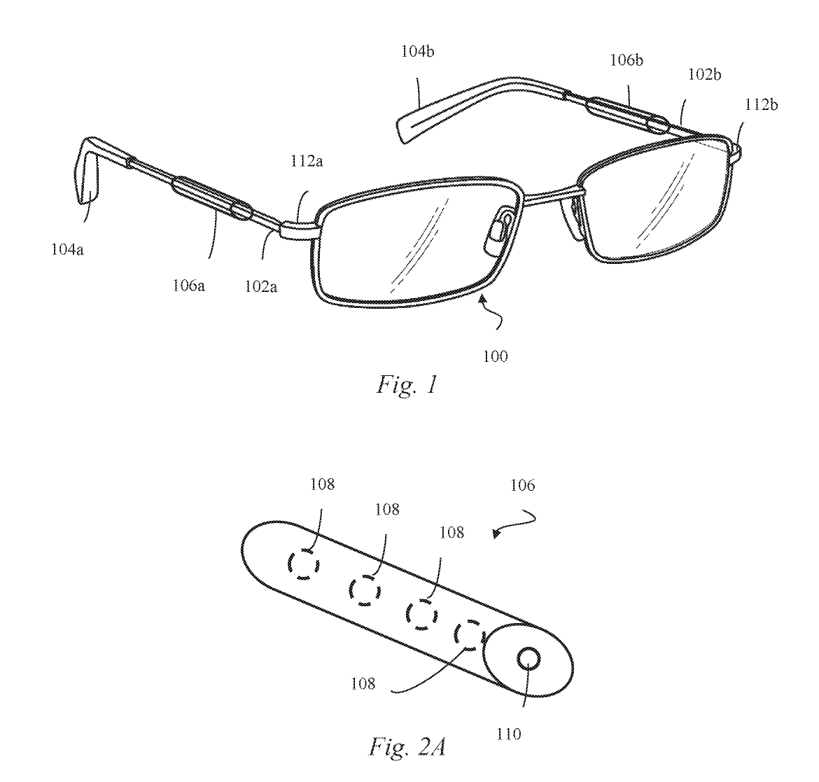

Referring to FIG. 1, an embodiment of the present invention includes a pair of sleeves 106a, 106b designed to respectively ensleeve the left and right temple pieces 102a, 102b. In an embodiment, sleeves 106a, 106b are comprised of a resilient flexible material enabling sleeves 106a, 106b to slide over end caps 104a, 104b before compressing around temple pieces 102a, 102b. Preferably, each flexible sleeve 106a, 106b has an inner diameter 110 sized to deliver adequate compression forces to secure the location of sleeve 106a, 106b along the longitudinal axis of the temple pieces 102a, 102b.

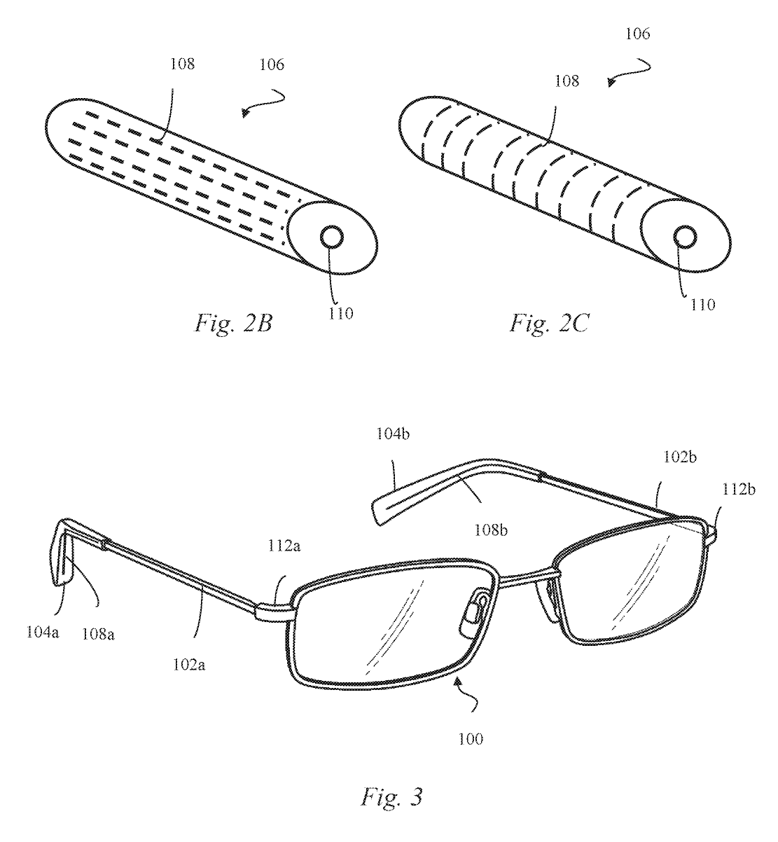

Referring now to FIGS. 2A-2C, each sleeve 106 includes one or more magnets 108. The exemplary embodiment depicted in FIG. 2A includes four (4) longitudinally spaced cylindrical permanent magnets. Any number of magnets may be used so long as the magnets provide an amble magnitude of attractive magnetic forces.

Permanent magnets 108 are disposed within sleeve 106 preferably between inner diameter 110 and the outer diameter of sleeve 106. As an alternative, magnets 108 may be sandwiched between temple piece 102 and inner diameter 110 of sleeve 106 or may sit flush with the outer surface of sleeve 106.

In an embodiment, sleeve 106 includes at least two sets of longitudinally aligned magnets with the first set of magnets diametrically opposed from the second set of magnets. In other words, the first set of magnets are circumferentially spaced one hundred and eighty (180) degrees about sleeve 106. The diametrically opposed spacing ensures that there is always a set of magnets located on an inboard side and an outboard side of the sleeve 106. As a result, the sequence of folding the left and right temple pieces 102a and 102b inward is not critical. In addition, the sleeve may include imprinted indicators for the location of the sets of longitudinally aligned magnets. Thus, an installer will know exactly where the magnets are located to ensure that the magnets from each sleeve will be aligned when the temple pieces are folded onto one another.

Referring to FIG. 2B, an embodiment includes one or more magnetic rods 108 running parallel to the longitudinal axis of the sleeve 106. Preferably, sleeve 106 includes a plurality of magnetic rods 108 circumferentially spaced equidistantly about sleeve 106. In an embodiment, each magnetic rod includes a magnetically positive end and a magnetically negative end. Preferably every magnetic rod in a sleeve is oriented in the same direction such that the negative magnetic poles are located at one end of the sleeve and the positive magnetic poles are located at the other end of the sleeve. Alternatively, the magnetic rods located within a first half of the circumference of the sleeve may all be oriented in the same direction with the magnetic rods located in a second half of the circumference of the sleeve inversely oriented. In other words, the magnetic poles of the rods in one half of the circumference of the sleeve are aligned and the magnetic poles of the rods in the second half of the circumference of the sleeve are oppositely aligned with respect to the rods in the first half. Consequently, half of the sleeve is magnetically attracted to the other half of the sleeve to aid in securing the sleeve to a temple piece.

This embodiment of sleeve 106 further includes magnetic pole indicators imprinted on the sleeve. The sleeves are inversely oriented on their respective temple pieces causing a positive magnetic pole on sleeve 106a to aligned with a negative magnetic pole on sleeve 106b, and vice versa. The opposite magnetic poles attract each other when the temple pieces are folded together and the magnetic force secures the temple pieces together.

FIG. 2C provides another exemplary embodiment of sleeve 106. Magnets 108 are circumferentially aligned and longitudinally spaced about sleeve 106. As explained above, magnets 108 include a positive magnetic pole at one end and a negative magnetic pole at the other end of the magnet. Because magnets 108 traverse the sleeve in a circumferentially oriented manner, the magnetic fields change from positive to negative as the magnet circumvents the sleeve. Thus, half of the circumference of sleeve 106 is dominated by a negative magnetic pole, while the other half of the circumference is dominated by a positive magnetic pole. In an embodiment, the polarity of the magnetic poles is imprinted on the corresponding circumference of sleeve 106.

The magnetic rods in FIGS. 2B and 2C may be comprised of rigid, semi-rigid, or flexible material. In addition, sleeve 106 may employ any number magnets having any size and shape.

In an alternative embodiment, magnetic sleeve 106 may be configured to hingedly open and clamp around a temple piece, similar to the actuation of a C-clamp. Further, the sleeve may be more of a ring-shape rather than an elongated sleeve. Consumers may prefer the aesthetic appeal of a metallic ring rather than an elongated sleeve. In an embodiment, the sleeves/rings may contain aesthetic features, including but not limited to, advertisements, desirable imprints/patterns, or fashionable colors and materials.

In contrast, an embodiment of magnetic sleeve 106 may have a single open end sized to receive a temple piece. The opposite back end is closed and abuts the distal free end of the temple piece when the sleeve is fully pulled onto the temple piece.

Referring now to FIG. 3, an embodiment includes magnets 108 disposed within end caps 104. This embodiment relies on temple pieces 102 and/or end pieces 112 being comprised of or including magnetically receptive materials disposed therein. When temple pieces 102 are folded inwards towards the lenses of the eyeglasses 100, end caps 104 will likely reside in overlying relation to temple pieces 102 and/or end pieces 112.

FIG. 3 depicts magnets 108 as generally linear in shape. The shape is intended to increase the likelihood of magnet 108 residing in overlying relation to a magnet receptive material when temple pieces 102 are folded inwards. It is considered that any shape magnet and any number of magnets may be disposed within end caps 104.

End caps 104 may be aftermarket ends caps that slide over the distal ends of temple pieces 102 or end caps 104 may be original end cap that are remove to insert a magnet and then reattached.

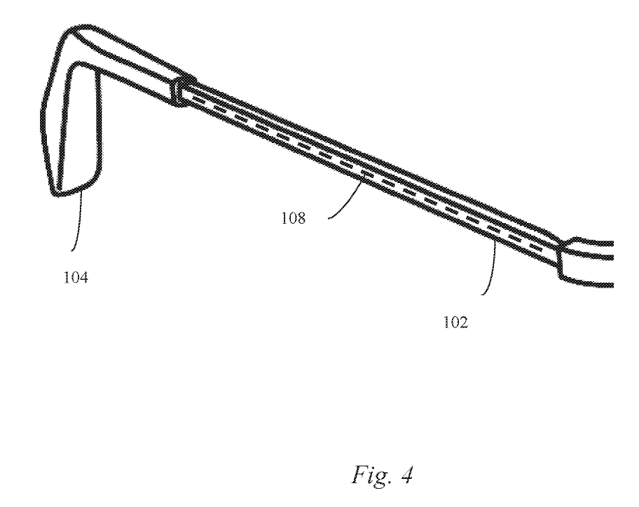

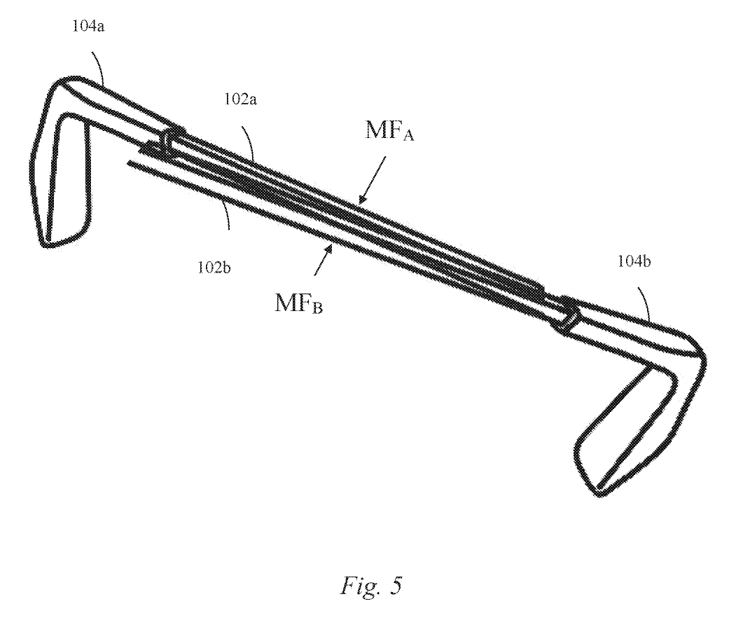

Referring now to FIG. 4, an embodiment includes temple piece 102 having magnet 108 disposed therein. Temple piece 108 is depicted as having magnet 108 longitudinally disposed within the body, but it is considered that any shape magnet and/or any number of magnets may be disposed within the body of temple piece 102. In addition, the magnets may be secured flush to the surface of the temple pieces. The exposed surfaces of these magnets may include aesthetically pleasing features, such as fashionable colors, shapes, and/or surface designs.

In an embodiment, eyeglasses 101 can be manufactured with a magnetically charged temple piece, such that no aftermarket modifications are required. Moreover, it is considered that the body of the temple piece itself may be comprised of magnet material. Pre-manufactured embodiments are more aesthetically pleasing because there isn't a need for any aftermarket external attachments.

In an embodiment, only one temple piece is adapted with a magnet, while the other temple piece or portion of the eyeglasses simply include material responsive to magnetic forces.

Glossary of Claim Terms

Temple Piece: is a support member hingedly secured to the frame of pair of eyeglasses proximate to a lateral end of the frame. The temple piece is intended rest proximate to a user's temple and overtop a user's ear when the eyeglasses are properly worn.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A method for securing a eyeglasses to an article of clothing, comprising:
placing a first temple piece proximate a first surface of the article of clothing, wherein the first temple piece includes a magnetic device incorporated therein or attached thereto;
folding a second temple piece towards a frame of the eyeglasses about a hinge connecting the second temple piece to the frame of the eyeglasses, wherein the second temple piece includes a magnetic device incorporated therein or attached thereto;
folding the combination of the frame of the eyeglasses and the second temple piece towards the first temple piece about a hinge connecting the first temple piece to a frame of the eyeglasses, wherein the combination of the frame of the eyeglasses and the second temple piece resides on a second surface of the article of clothing such that the article of clothing is sandwiched between the first temple piece and the combination of the frame of the eyeglasses and the second temple piece; and
allowing a magnetic field of the magnetic device incorporated or attached to the first temple piece to reach a magnetic field of the magnetic device incorporated or attached to the second temple piece, thereby causing the first and second temple pieces to magnetically attach to each other securing the article of clothing therebetween.

2. A pair of eyeglasses comprising:
a first magnetic device secured to or incorporated into a first temple piece on the pair of eyeglasses;
a second magnetic device secured to or incorporated into a second temple piece on the pair of eyeglasses;
the first and second magnetic devices each located along their respective temple pieces at locations that cause a magnetic field of the first magnetic device to reside within a magnetic field of the second magnetic device when the first and second temple pieces are folded inwardly towards a frame of the pair of eyeglasses;
the magnetic fields of the first and second magnetic devices oriented such that the two magnetic fields produce an attraction force thereby pulling the first and second temple pieces into contact with each other; and
the attraction force having a force value greater than the weight of the pair of eyeglasses when the first and second temple pieces are in contact with each other.
